(19) United States
(12) Patent Application Publication
(10) Pub. No.: US 2004/0201693 A1
(43) Pub. Date: Oct. 14, 2004

(54) Image processing system

(75) Inventor: Yoshiyuki Endo, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/817,837

(22) Filed: Apr. 6, 2004

(30) Foreign Application Priority Data
Apr. 8, 2003 (JP) 2003-104079

(51) Int. Cl. H04N 5/225; H04N 1/46

(52) U.S. Cl. 348/207.1

(57) ABSTRACT

Provided is an image processing system having a camera section and a main body section which are separable one from the other in which three separate exclusive buses are used for data communication between the camera section and the main body section, the three separate exclusive buses being: a first exclusive bus for transferring from the camera section to the main body section image data to check a subject on a display unit of the main body section before an image to be recorded is picked up on the main body section side; a second exclusive bus for transferring the image file to be recorded on the main body section side from the camera section to the main body section; and a third exclusive bus for transferring control data between the camera section and the main body section.

### BACKGROUND OF THE INVENTION

1. Field of the Invention

The present invention relates to image transfer/control in an image processing system constructed such that a camera section and a main body section are physically separable one from the other.

2. Related Background Art

FIG. 8 is a block diagram showing an arrangement of a conventional digital camera generally used.

In FIG. 8, a lens group 701 may be a lens group of a fixed-focus type or a zoom lens group having a predetermined zooming factor. An image pickup element 702 is a CCD, for example. An image pickup element control unit (CCD control unit) 703 includes a timing generator (TG circuit) for supplying a transfer clock signal and a shutter signal to the image pickup element 702, a CDS/AGC circuit for removing noise from an image signal output from the image pickup element 702 and for carrying out gain adjustment processing, and an A/D converter for converting an analog image signal into a 10-bit digital signal. The image pickup element control unit 703 constantly outputs image data of 30 frames per second. Most of the CDS/AGC circuits and the TG circuits are controlled through a synchronous serial communication from an IC 704 which executes various processings of a digital camera function.

The IC 704 carries out processes of white balance adjustment, shutter speed control, iris control, and the like, and converts the results of the processings into Y/Cb/Cr digital image signals to output the digital image signals. In the digital camera of FIG. 8, the IC is further connected to a work memory 705 for a work area, such as a RAM which is required for executing the processing, a removable memory card 707 as a storage device, and a key switch group 708 including a shutter switch and a mode selection switch. The IC is further connected to an NTSC output IC 708 to display on an NTSC display 709 an image from the IC704. A program for executing the processing by the IC 704 is stored in a program memory 710. A lens drive motor unit 711 controls the focusing and zooming operations of the lens group 701.

A displaying process of the image signal by the IC 704 will now be described.

An internal operation in a mode, usually called a finder mode, which is executed before the image recording operation, will be described. In the finder mode, an image is merely displayed on a screen of the NTSC display unit 709. The IC 704 outputs data for setting a finder mode in the image pickup element control unit 703 through a synchronous serial communication. Upon reception of the data, the image pickup element control unit 703 outputs various types of control clock signals corresponding to the finder mode to the image pickup element 702. In this state, an optical image that is captured through the camera lens 701 is converted into an electrical signal by the image pickup element 702. Then, the IC 704 processes the image output from the image pickup element control unit 703, and outputs image data that has undergone size reduction into a pixel size necessary for display. The image data is usually output at a rate of 13.5 MHz per dot, 30 frames per second, and 640×480 dots per frame, with the data format of Y/Cb/Cr (4:2:2).

The NTSC output IC 708 converts the output image data into image data of 60 frames per second (each frame: about 720×240 dots) by dividing image data of 30 frames per second (each frame: about 720×480 dots) into even and odd frames, and outputs the resultant to the NTSC display unit 709.

A still image recording operation of the conventional digital camera will be described.

When the shutter switch is depressed in a still image taking mode, the IC 704 stops a finder operation, and transfers data for instructing the image pickup element control unit 703 to change the operation of the digital camera from pixel skipping operation that is performed in the finder mode into an operation for taking in all pixels of the CCD, to the image pickup element control unit 703 through a synchronous serial communication. Specifically, the image data that is output from the image pickup element in the finder operation is curtailed in the vertical direction into ¼ of the total image data. At the time of taking in all the pixels, however, the whole image data of the image pickup element (CCD) 702 is output while divided into several frames.

The IC 704 develops the data of all the pixels, which is output to the work memory 705 and then subjects the data to JPEG compression, and stores the same into the card 707.

Next, a moving image recording operation by the conventional digital camera will be described. A so-called motion JPEG method is being widely used for the moving image taking operation in the conventional digital camera.

When the shutter switch is depressed in the moving image recording mode, image data input to the IC 704 is filed into JPEG data, temporarily recorded on the work memory 705, and then transferred to the memory card 707, as in the data flow in the finder mode which is described in relation to an operation of outputting the display signal. This process is successively carried out while the shutter switch is depressed. Since there is a limit in a rate at which the data is transferred to the memory card 707, the specifications of the digital camera are limited such that the continuous photographing time is 15 seconds under conditions that an image size is VGA (640×480) or smaller, and a frame rate is 15 fps or lower.

The conventional integration type digital camera is described above. The present invention relates to a separation type image processing system constructed such that a camera section and a main body section are physically separated one from the other along a broken line as denoted by 712.

When the digital camera of FIG. 8 is simply separated physically, signal lines connecting the image pickup element control unit 703 and the digital camera function IC 704 are a signal line for a synchronous serial communication signal for controlling the image pickup element control unit 703 and a signal line for image data output in parallel from the image pickup element control unit 703.

Problems of the image processing system are as follows. When it is desired to change the number of pixels of the image pickup element, the IC for CDS/AGC/AD and the IC for TG in the image pickup element control unit must also be altered corresponding to the image pickup element. Accordingly, the user must replace the image processing system (digital camera) per se.

A high speed serial interface of USB, IEEE1394 or the like is widely used for the connection between the separation type camera and a personal computer (PC).

When the number of pixels of the image pickup element is equal to or larger than 2,000,000, for example, the following problems arise. When three kinds of data, i.e., finder image having the VGA sizes and the transfer rate of 30 fps, a still image of 2,000,000 pixels after JPEG compression, and a control command for controlling the camera section, are transferred in time division through the serial communication by the USB, power consumption increases since a clock rate of the memory clock signal for writing the high speed serial data in the memory is high. A data transfer rate decreases because of the overhead in the time-division control. Further, it is difficult to manage the real-time data switching by software.

For the connection type camera module using the CF card interface, which is mainly used in PDA, there is a limit in the data transfer amount of the CF card interface. It cannot even transfer the finder data of the VGA size

### SUMMARY OF THE INVENTION

The present invention has been made in view of the problems in the conventional technique and accordingly, a feature of the present invention is to provide an image processing system which allows various types of image pickup modules to be used, and realizes real-time data management according to operation circumstances.

To solve the above problems, the present invention provides an image processing system having a camera section and a main body section which are separable one from the other in which three separate exclusive buses are used for data communication between the camera section and the main body section, the three separate exclusive buses being: a first exclusive bus for transferring from the camera section to the main body section image data to check a subject on a display unit of the main body section before an image to be recorded is picked up on the main body section side; a second exclusive bus for transferring the image file to be recorded on the main body section side from the camera section to the main body section; and a third exclusive bus for transferring control data between the camera section and the main body section.

Other features of the present invention will become apparent from the following detailed description in this specification in conjunction with the accompanying drawings.

### BRIEF DESCRIPTION OF THE DRAWINGS

FIG. 1 is a block diagram showing an image processing system according to a first embodiment of the present invention;

FIGS. 2A, 2B and 2C are wave form charts of various signals when a finder image displaying operation is performed;

FIG. 3 is a wave form chart of signals on file transfer exclusive buses;

FIG. 4 is a time-series transition diagram showing processing operation periods in the image processing system when image pickup and recording operations are performed;

FIG. 5 is a block diagram showing an image processing system according to a second embodiment of the invention;

FIG. 6 is a block diagram showing an image processing system according to a third embodiment of the invention;

FIG. 7 is a flow chart illustrating an operation processing flow of the image processing system; and

FIG. 8 is a block diagram showing a conventional digital camera.

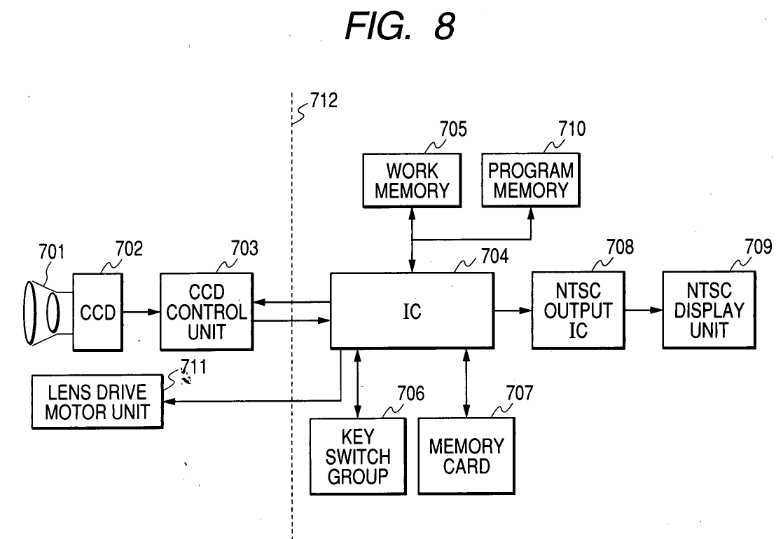

### DESCRIPTION OF THE PREFERRED EMBODIMENTS

Hereinafter, an embodiment of the present invention will be described.

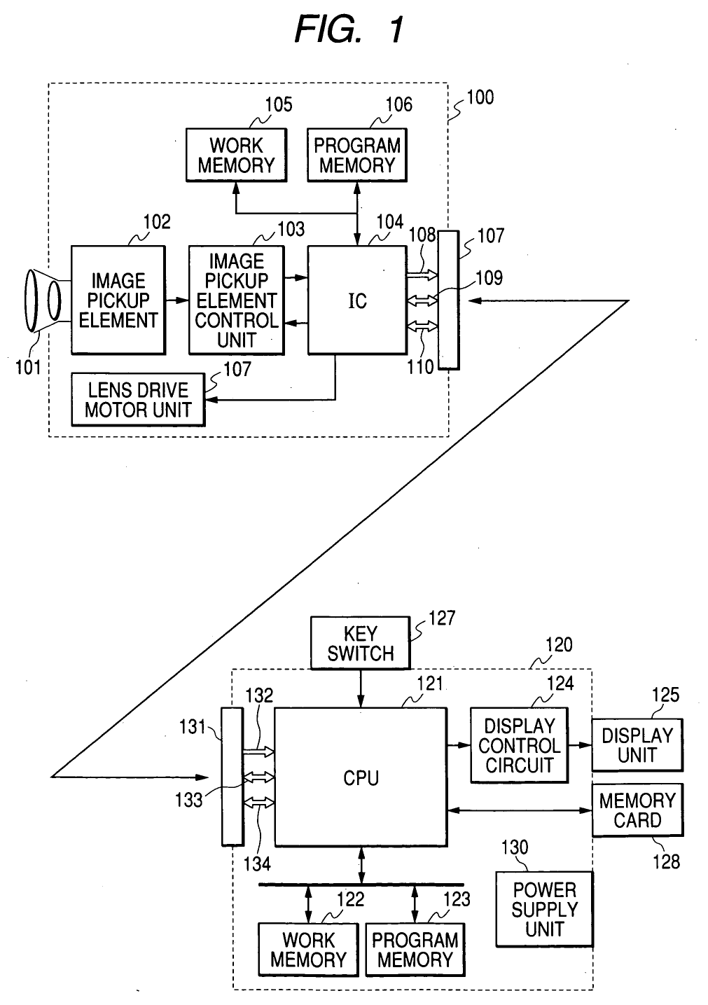

FIG. 1 is a block diagram showing a schematic configuration of a separation type image processing system according to a first embodiment of the present invention. In this embodiment, first to third serial buses are separately provided. The first serial bus is exclusively used for transferring from a camera section to a main body section image data to check a subject on a screen of a display unit of the main body section before an image to be recorded is picked up on the main body section side. The second serial bus is exclusively used for transferring an image file to be recorded on the main body section side from the camera section to the main body section. The third serial bus is exclusively used for transferring control data between the camera section and the main body section.

In FIG. 1, a camera section 100 is physically separable from the main body section. A lens group 101 is replaceable with another lens group, and light from a subject is incident on an image pickup element 102. The image pickup element 102 converts an image taken through the lens group 101 into an electrical signal. An image pickup element control unit 103 includes a CDS/AGC processing circuit and an A/D converter circuit, which are for adjusting an analog signal output from the image pickup element 102 and converting the analog signal into a digital signal, and a timing generator for generating a timing signal for driving the image pickup element 102.

An IC 104 controls the image pickup element control unit 103 through a synchronous serial communication, controls an exposure, and executes various processings (white balance processing, generation/output of a finder image (640×480 dots) in a finder mode, and generation of a JPEG file of the photography image) of a digital image signal output from the image pickup element control unit 103.

A camera work memory 105 is an SDRAM, an SRAM or the like, and used for the JPEG decompression, image size conversion, and the like. A program memory 106 is a ROM in which a control program for the IC 104 is stored.

A camera-side connector 107 is a connector of the camera section 100 which is for connecting the camera section 100 and the main body section 120. A finder output exclusive bus 108 is exclusively used for outputting finder image data output from the IC 104. A camera-side file transfer exclusive bus 109 is exclusively used for transferring file data between the IC 104 in the camera section 100 and a CPU 121 in the main body section 120. A camera-side control command exclusive bus 110 is exclusively used for transferring control commands between the IC 104 of the camera section 100 and the CPU 121 of the main body section 120.

The main body section 120 is physically separable from the camera section. In response to an input signal from a key switch 127, the CPU 121 controls the related devices, viz., it controls the IC 104 and an operation for displaying an image on a TFT liquid crystal display unit 125.

The CPU 121 includes a so-called microprocessor, and further a so-called SOC (system on chip) including logic circuits, such as a YC-RGB conversion logic circuit for the finder data, and a memory controller for controlling external memories, e.g., a program memory 123 and a work memory 122.

The work memory 122 is connected to a memory bus and used for the image decompression area and the work area, which are used by the CPU 121. The program memory 123 is connected through the memory bus, and stores a control program for controlling the related devices, and font data. A display control circuit 124 receives RGB signals and a sync signal from the CPU 121, and generates and outputs a signal for displaying an image on the TFT liquid crystal display unit 125. The display unit 125 is composed of a TFT type liquid crystal display of the VGA size, and the like. The key switch 127 detects switches for various types of controls, such as a shutter switch and a mode switch. A memory card 128 is a removable storage device connected to the CPU 121 by means of a connector, through an exclusive bus.

A power supply unit 130 supplies electric power to various devices in the main body section 120 and the camera section 100. In this embodiment, the power supply unit supplies electric power to the main body section 120, and electric power to the camera section 100, through a main body side connector 131 and the camera-side connector 107.

The main body side connector 131 is a connector which is provided on the main body section 120, and is used for connecting the camera section 100 and the main body section 120. A finder input exclusive bus 132 is exclusively used for inputting finder image data (image data for checking a subject on the display unit 125 before an image to be recorded is actually picked up) output from the IC 104 in the camera section 100 to the CPU 121 via the camera-side connector 107 and the main body side connector 131.

A main body side file transfer exclusive bus 133 is exclusively used for transferring file data between the IC 104 and the CPU 121. A main body side control command exclusive bus 134 is exclusively used for transferring control commands between the IC 104 and the CPU 121. It is assumed that this embodiment employs a standard serial communication method, called a UART, for transferring the control commands.

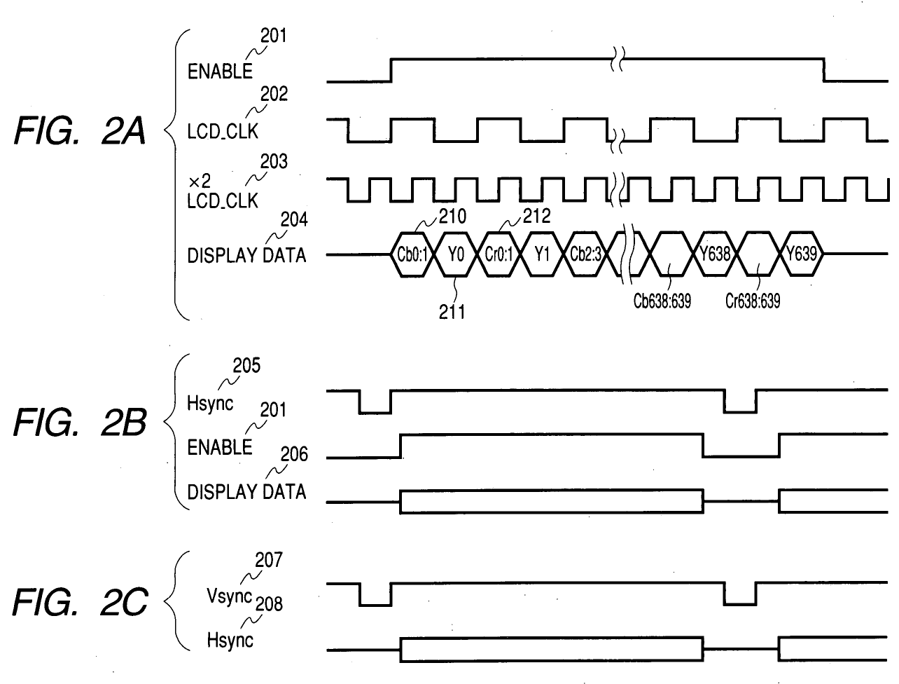

FIGS. 2A to 2C are wave form charts of various signals output from the IC 104 when a finder image is displayed on the display unit 125. In this embodiment, description is given about finder data when an image of a size of VGA (640×480 dots) is displayed. In FIGS. 2A to 2C, time axes are the same.

In FIGS. 2A to 2C, a signal 201 is an ENABLE signal indicating an effective data part of the VGA size in the image data (8-bit Y/Cb/Cr signal) 204. A signal 202 is a signal LCD_CLK as a reference signal for the whole finder output part, and its frequency is about 13.5 MHz. A signal 203 is a signal x2LCD_CLK obtained by ½ frequency-dividing the signal LCD_CLK 202 and used as a reference signal for the display data 204. Its frequency is about 27 MHz. A signal 204 is representative of 8-bit display data that is output in synchronization with a trailing edge of the signal x2LCD_CLK.

A signal 205 is a horizontal sync signal (Hsync) indicating a data start period in the horizontal direction. A period of the Hsync signal is equal to a period of about 700 clock pulses for each signal LCD_CLK 202. A signal 206 is representative of finder image data simplified by reducing its time axis for clarifying a relationship between the signal and the Hsync signal 205.

A signal 207 is a vertical sync signal (Vsync) indicating a data start period in the vertical direction. A period of the signal Vsync is equal to a period of about 640 Hsync signals. A signal 208 is an Hsync signal simplified by reducing its time axis for clarifying a relationship between the signal and the Vsync signal 207. A signal 210 is an 8-bit color difference signal (Cb signal) which corresponds to data mainly regarding blue color information. Reference numeral 211 designates an 8-bit luminance signal (Y signal) which corresponds to data mainly regarding brightness information. Reference numeral 212 designates an 8-bit color difference signal (Cr signal) which corresponds to data mainly regarding red color information.

The signal 204 is based on a signal format of the display data in CCIR-601. The signal 204 is output, by 8 bits, in synchronization with at the trailing edge of the signal x2LCD_CLK at the instant when the ENABLE signal 201 turns its level to High. For the data output, one luminance signal is present for each display pixel, and each color difference signal is present for every two dots according to a format of Y/Cb/Cr=4:2:2. Accordingly, a data amount for one dot is defined by one luminance signal and one color difference signal. For each luminance signal and each color difference signal, data of 8 bits is used, and hence, 16-bit data is obtained.

To display one frame having effective pixels of 640×480, a period of about 700 clocks×640 lines is required, and the effective pixels of 640 dots×480 lines are included in the frame. The finder data output from the digital camera control IC 104 is updated about 30 times per second, and the clock rate per dot is 13.5 MHz as mentioned above. Accordingly, an effective data transfer capacity in the finder data is about 19 MB/s.

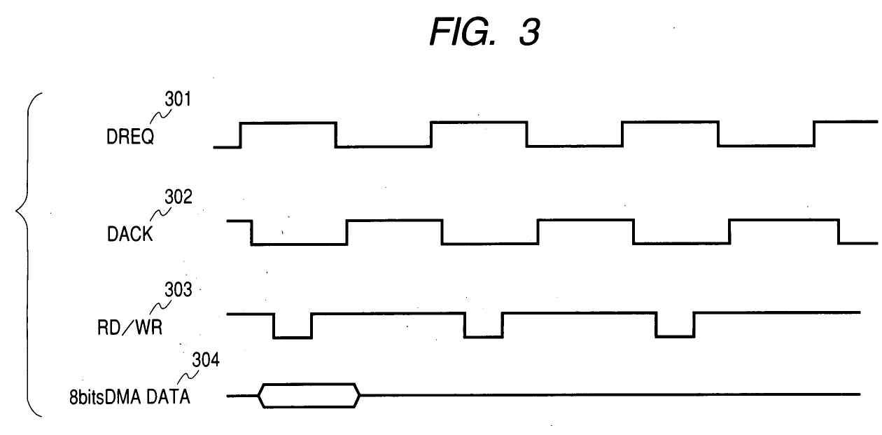

FIG. 3 is a wave form chart of signals on the file transfer exclusive buses (109, 133) through which file data is transferred between the IC 104 of the camera section 100 and the CPU 121 of the main body section 120. This embodiment employs a data transfer system, called a DMA transfer system, which does not require address control. The DMA transfer system is suitable for a case where a large amount of data is transferred for a short time by using a small number of data lines. In this case, the IC 104 serves as a master. The file transfer exclusive bus may be realized by utilizing a system based on USB, IEEE1394, or the like.

In FIG. 3, the signal 301 is a data request signal (DREQ signal) which is output form the CPU 121 of the main body section 120 and input to the IC 104 of the camera section 100, and is used for requesting file transmission or file reception.

A signal 302 is a data acknowledge signal (DACK signal) which is output when the DREQ signal 301 from the CPU 121 is used for determining that the IC 104 in the camera section 100 is allowed to transfer a file to the CPU 121, and as a result, data transfer is allowed or receive buffer is put in a permission state in the IC 104.

A signal 303 is an RD/WR signal representing a latch timing of the 8-bit DMA data 304 in a read (RD) or write (WR) mode in the IC 104 in a state that the IC 104 renders the DACK signal 302 Low (L) in level to permit data transmission/reception to and from the CPU 121. This signal is output from the IC 104 as the master.

The signal 304 is an 8-bit DMA data signal as file transfer data which is output from the CPU 121 in a read mode, and is output from the IC 104 in a write mode.

For the data transfer in the DMA, the data transfer capacity is determined depending on a response time taken for the DACK signal 302 and the RD/WR signal 303 that are output from the IC 104 after the DREQ signal 301 output from the main body section 120 is rendered active. When the DACK signal 302 has a frequency of 10 MHz, the transfer capacity is 10 MB/s.

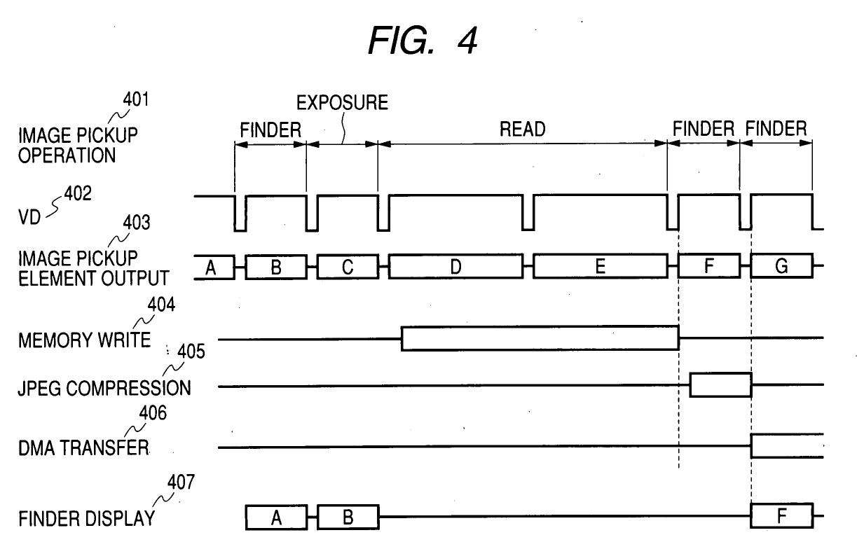

FIG. 4 is a time-series timing chart showing processing operation periods in the image processing system when a still image is captured (recorded) in this embodiment.

In FIG. 4, an image pickup operation 401 includes a sequence of major operations in the CPU 121. In the photographing operation, a “finder” is a finder mode in which the curtailed output image data is displayed without performing the recording operation. An “exposure” indicates a data exposure period for reading out all of the pixels for recording a still image (recording operation is targeted at all the pixels). A “read out” indicates a period for outputting from the image pickup element 102 the image data of all of the pixels of the image pickup element 102 which is exposed during the “exposure” period.

A signal 402 is a control signal which is output from a timing generator in the image pickup element control unit 103 for controlling the image pickup element 102, and also is a CCD vertical sync signal (VD signal) which turns its level to Low (L) every about 33 ms in a finder mode and every 16 ms in a read mode. The VD signal is used as a reference for outputting the data from the image pickup element 102, and a period ranging from the L level to the next L level is expressed in terms of a frame. An image pickup signal output 403 indicates data outputting periods of a still image to be recorded, which is output from the image pickup element 102.

A memory write 404 indicates a memory write period necessary for the IC 104 to write all of the pixel data (D and E in the image pickup element output 403) output from the CCD 102 into the work memory 105. A JPEG compression 405 indicates a period necessary for the IC 104 to read out still image data to be recorded, which is written in the work memory 105, perform JPEG compression of the data, and rewrite the JPEG compressed data into the work memory 105.

A DMA transfer 406 indicates a period for transferring a JPEG file that is written in the work memory 105 from the IC 104 to the CPU 121 by use of the camera-side file transfer exclusive bus 109 of the camera section 100.

A finder display 407 indicates a correlation between an output period of image data output from the image pickup element 102, which is shown in the image pickup signal output 403, and display image data that the IC 104 outputs to a finder output exclusive bus 108. When the image pickup operation 401 of the CPU 104 is the “finder” mode, an output A in the image pickup element output 403 is displayed as image display data A during a period indicated by the finder display 407, in the next frame. Subsequently, the image pickup element output 403 of an output B is also displayed as image display data B during a period shown in the finder display 407 with delay of one frame.

The same thing is correspondingly applied to timings in the finder mode that is restored from the exposure/read process, and it is output as finder display with delay of one frame of the image output in the image pickup signal output 403.

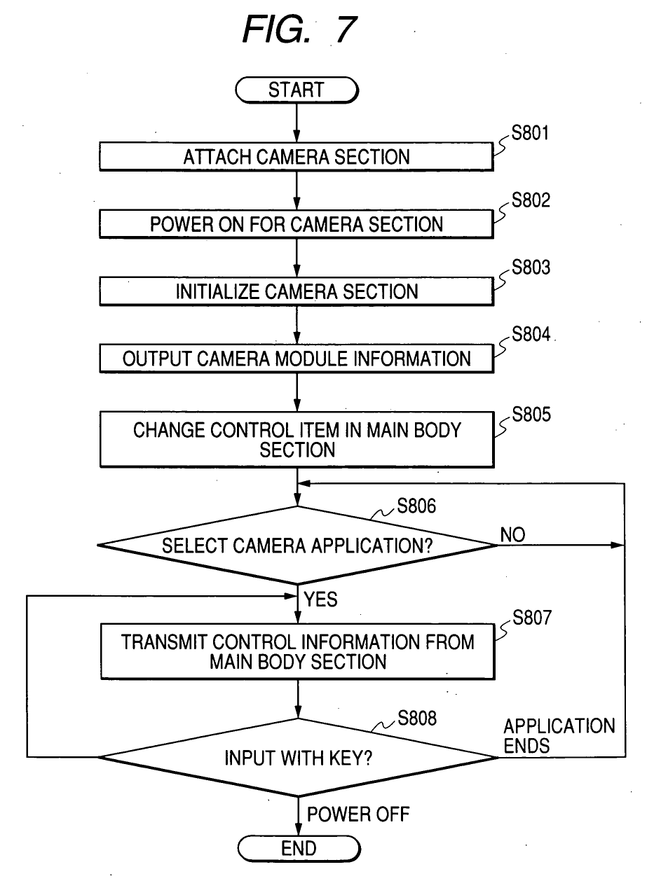

Each data bus control and data flow when a still image is captured in this embodiment will be described with reference to FIGS. 1 to 4, and FIG. 7. FIG. 7 is a flow chart showing an operation processing flow in the image processing system in this embodiment.

To start with, an operator attaches the camera section 100 to the main body section 120 (step S801). The power supply unit 130 starts to supply electric power not only to the main body section 120 of the camera section 100 but also to the camera section 100 (step S802). After an initializing process in the camera section 100 ends (step S803), it outputs camera module information containing various information to the CPU 121, through the control command exclusive bus 110 of the camera section 100 (step S804). Such information includes, for example, pixel information indicating that the image pickup element 102 has 2,000,000 pixels, and zooming factor information of the lens group 101.

Upon reception of the camera module information transferred, the main body section 120 updates the information setting in an application using the camera section 100 (step S805). Thereafter, when the application using the camera section 100 is selected by the operator (step S806), it outputs a control command to the camera section, which is based on a status of the application, through the main body side control command exclusive bus 134 (step S807). This process continues till the application ends or the power supply unit is turned off (step S808).

In step S806, when the operator selects a still image capturing application by use of the key switch 127, the CPU 121 instructs the start of a finder operation, by a UART, through the main body side control command exclusive bus 134. The instruction is transferred to the IC 104, through the camera-side control command exclusive bus 110.

Upon reception of the instruction of the finder operation, the IC 104 outputs a transmission data output instruction for a finder to the image pickup element control unit 103 by a synchronous serial transfer, in order to perform the finder operation. In response to the instruction, the image pickup element control unit 103 outputs image data for finder operation (A, B, F, and G in the image pickup element output 403) to the IC 104. Upon reception of the image data for finder operation, the IC 104 generates control data for auto-focusing and exposure control based on the image data, and corrects white balance of the image data. After curtailing and expanding the image data to the VGA size, the IC 104 transfers the resultant as finder data (A, B, and F of the finder display 407) to the main body section 120, through the finder output exclusive bus 108.

When the display data 204 is set to 8-bit data in FIGS. 2A and 2B, a frequency of the signal x2LCD_CLK is about 27 MHz, and the effective data transfer amount is about 19 MB/s for the signal of such a frequency. The output of the data is stationarily continued till the still image capturing operation starts. A format of the finder data acquired through the finder input exclusive bus 132 is different from that of the data processed in the display control circuit 124. Accordingly, it is impossible to directly output the image data to the display control circuit 124. To this end, the Y/Cb/Cr signal is converted into an RGB signal by using the following conversion formulae, and the converted one is output to the display control circuit 124 and the display unit 125.

R=1.16Y+1.59Cr

G=1.16Y−0.81Cr−0.39Cb

B=1.16Y+2.018Cb

Then, when the operator depresses a zoom key or an exposure control key contained in the key switch 127 of the main body section 120, the CPU 121 determines an on state of the key switch depressed. When the depressed key is the zoom key, the CPU 121 gives an instruction to operate a zoom motor or to stop the operation of the zoom motor through the main body side control command exclusive bus 134, by use of the UART. When the depressed key is the exposure control key, the CPU 121 gives an instruction to increase or decrease a brightness of the image. The IC 104 receives those instructions through the main body side control command exclusive bus 134, and controls a lens drive motor unit 107A for the zooming operation. For the exposure control, the IC 104 rewrites a register value within the IC 104 or an analog gain value in the image pickup element control unit 103, and further controls a read period or the iris.

When the operator depresses a shutter switch contained in the key switch 127, the CPU 121 detects a signal from the shutter switch, and gives an instruction to stop the finder operation through the main body side control command exclusive bus 134, by the UART, and subsequently gives an instruction to start to take in all of the pixels (start to pick up a still image to be recorded into the CF card). Upon receiving the instruction to take in all of the pixels, the IC 104 outputs a parameter for performing an exposure mode in the image pickup operation 401 to the image pickup element control unit 103 by the synchronous serial transfer.

Upon receiving the instruction, the image pickup element control unit 103 successively outputs still image data for exposure operation (D and E of the image pickup signal output 403) to the IC 104. The still image data that is input to the IC 104 during a “read” period in FIG. 4 is all written into the camera work memory 105. After all of image data has been written into the camera work memory 105, the IC 104 gives a transmission data output instruction for finder to the image pickup element control unit 103 by the synchronous serial transfer in order to automatically return to the finder operation again. In turn, the image data of “F” of the image pickup signal output 403 is output from the IC 104 at a timing of the “F” in the finder display 407.

At the instant of returning to the finder operation (“F” of the finder display 407), the image data is JPEG compressed, and a file generated by the compression is written into the camera work memory 105. The IC 104 then transfers the JPEG compressed file to the main body section 120 via the camera-side file transfer exclusive bus 109. When receiving the JPEG compressed file, the CPU 121 temporarily transfers it to the work memory 122, and then writes it into the memory card 128.

As described above, according to this embodiment, in the system in which the camera section and the main body section are detachably attached to each other, separate signals lines are provided for connecting the camera section and the main body section. Those signal lines are “finder”, “file transfer”, and “command” lines, and independently operated. This unique feature successfully realizes a satisfactory transfer capacity, the lowering of operating frequency and power consumption, and easy data management.

With provision of the three buses having different functions, the system quickly returns from the photographing mode to the finder display mode. In this respect, the operation response performance is enhanced.

Further, elaborate controls of the image pickup element and the lens drive motor unit are executed by the IC. Accordingly, if any type of image processing unit is installed, the CPU can control it in the same way by using the “command” exclusive bus. This fact implies that any of various types of the camera sections can be applied to one main body section at low cost.

The embodiment mentioned above is characterized in that the transfer of control commands, image data for finder, and files between the IC 104 and the CPU 121 is controlled by use of the buses that are exclusively provided for them. Therefore, any camera section having such exclusive buses can be connected to the main body section 120.

Even if the image pickup element 102 in the camera section 100 whose number of pixels is as small as that of the VGA (640×480) is used, the image data for finder per se holds as all the pixel data not compressed. Accordingly, there is no need for the camera section 100 to have the file transfer exclusive bus. The camera section not having the file transfer exclusive bus can be attached to the main body section 120 of the first embodiment by rendering the file transfer in the main body section invalid through the control by a control command. Such a case will be described hereunder as a second embodiment of the invention.

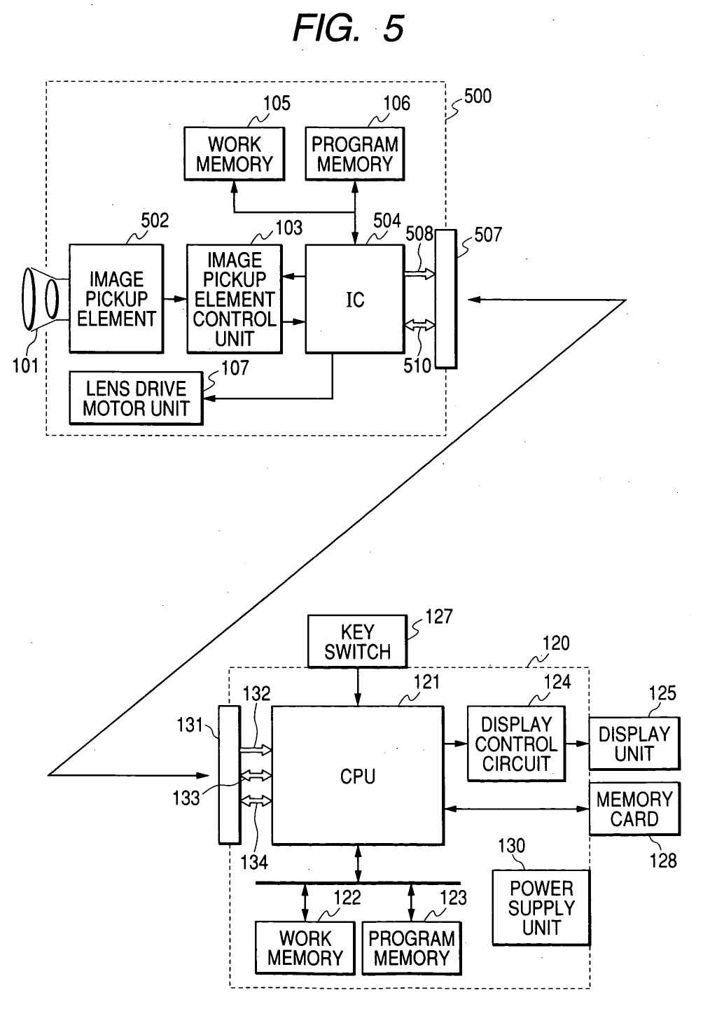

FIG. 5 is a block diagram illustrating a camera section and a main body section according to the second embodiment of the invention. In the figure, like or equivalent portions to those of FIG. 1 are designated by like reference numerals, and regarded as functioning and operating in like manners.

In FIG. 5, a camera section 500 includes an image pickup element 502 of the VGA size. The image pickup element 502 photoelectrically converts image data of 640×480 dots (VGA) and outputs the same.

An IC 504 controls the image pickup element control unit 103 through the synchronous serial communication so as to control exposure and white balance of the image data, output finder image (640×480 dots), and generate a JPEG file of a still image to be recorded.

A camera-side connector 507 is a connector of the camera section 500 which is provided for connecting the camera section 500 and the main body section 120. The camera-side connector 507 is merely provided with dummy connection terminals, and actually does not include the file transfer exclusive bus. A finder output exclusive bus 508 is used to output image data for finder so that the IC 504 displays the image data on a screen of the display unit 125. A camera control command exclusive bus 510 is a bus for transferring a control command between the IC 504 and the CPU 121.

An image processing system of this embodiment will be described with reference to FIG. 5.

When the main body section 120 is attached to the camera section 500, camera module information containing information about pixel information indicating that a CCD 502 of a VGA-equivalent size is installed is output from the camera section 500 to the CPU 121, through the camera control command exclusive bus 510.

When receiving this information, the CPU 121 of the main body section 120 does not yet output a still image file transfer request to the camera section 500 even when the shutter switch of the key switch 127 is depressed. The image data for finder output from the finder output exclusive bus 508 is also used as an image to be recorded into the memory card 128. Specifically, the image having the VGA-equivalent size is extracted onto the work memory 122, the extracted image is JPEG compressed in the CPU 121 to create a JPEG file on the work memory 122, and then the JPEG file is written into the memory card 128.

As described above, this embodiment can appropriately process the camera section having the image pickup element with a small number of pixels.

While the digital camera system of the type in which the lens unit can be replaced with another is discussed in each embodiment mentioned above, the main body section can be connected to a module other than the camera section 100 as far as the module has buses exclusively used for transferring the control command, the finder data, and the files.

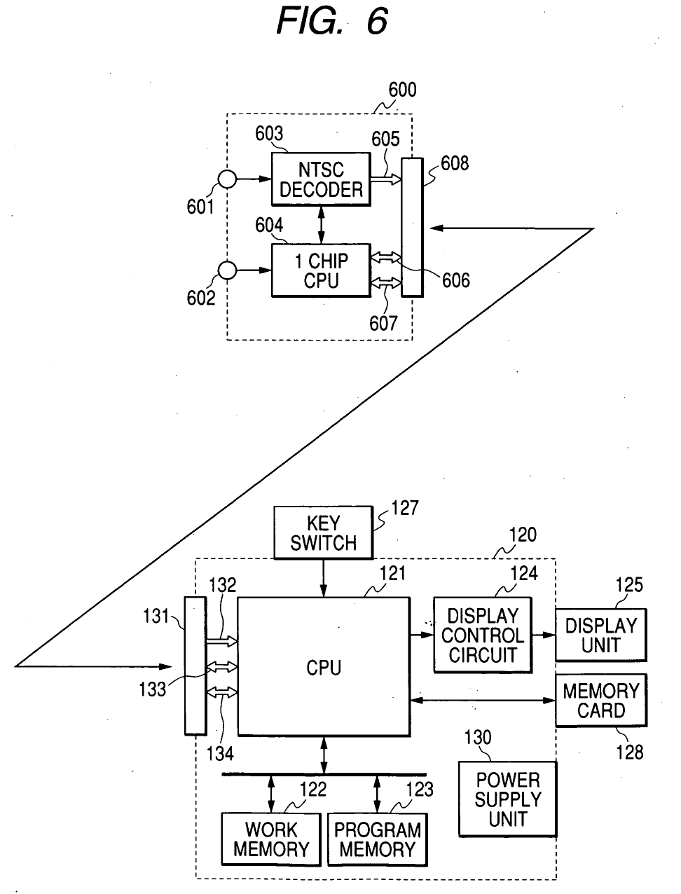

FIG. 6 is a block diagram showing a video signal processing unit and a main body section in an image processing system which is a third embodiment of the invention.

In FIG. 6, a video signal processing unit 600 supplies an NTSC video signal to a digital image main body where the NTSC video signal is displayed by the TFT liquid crystal display unit 125 and the video image is stored as digital image in the main body section 120. An NTSC input connector 601 is a connector through which an NTSC signal is input as an image signal to the video signal processing unit 600 from exterior. An audio input connector 602 is a connector through which an audio signal, together with the NTSC signal, is input to the video signal processing unit 600. An NTSC decoder 603 converts an analog NTSC signal coming from the NTSC input connector 601 into digital data, and outputs video data having the same format as that of the display data 204 which is based on the CCIR-601 format shown in FIGS. 2A to 2C. A 1-chip CPU 604 is a CPU containing a ROM and RAM, which records audio data coming from the audio input connector 602 in the form of digital data such as ADPCM data, and controls the NTSC decoder 603 based on a control command coming from a video-side control command exclusive bus 607.

A finder output exclusive bus 605 is a bus which outputs to the main body section 120 image data for finder for displaying it on a screen of the display unit 125. A file transfer exclusive bus 606 of the video signal processing unit 600 is a bus used when audio data is output from the 1-chip CPU 604 to the CPU 121. A control command exclusive bus 607 of the video signal processing unit 600 is a bus through which a control command is transferred between the 1-chip CPU 604 and the CPU 121.

This embodiment will be described with reference to FIG. 6.

When the video signal processing unit 600 is attached to the main body section 120, the 1-chip CPU 604 of the video signal processing unit 600 outputs to the main body section 120 information indicating that the unit of the 1-chip CPU is the video signal processing module, through the control command exclusive bus 607.

When an application, which is called a video display, is selected, the main body section 120 having the information indicating that the unit of the 1-chip CPU is the video signal processing module gives an instruction to output video data to the 1-chip CPU 604 of the video section, through the main body side control command exclusive bus 134.

In response to the instruction, the 1-chip CPU 604 instructs the NTSC decoder 603 to output the video data, thereby causing it to output the video data through the finder output exclusive bus 605. At the same time, the CPU outputs the video data coming from the audio input connector 602 to the main body section 120 in the form of digital data, through the file transfer exclusive bus 606 of the video signal processing unit 600.

When the shutter switch of the main body section 120 is depressed during the running of the video display application, the main body section 120 extracts an image having a VGA-equivalent size from the image data for finder output from the finder output exclusive bus 605, while not outputting a still image file transfer request to the video signal processing unit 600. The extracted image is JPEG compressed in the CPU 121, a JPEG file is generated on the work memory 122, and the file is stored into the memory card 128.

In this way, also in the image processing system to which the NTSC signal is input, the process is properly executed.

As described above, according to the present invention, in the system in which the video signal processing unit and the main body section are detachably attached to each other, the separate signal lines are provided for connecting the video signal processing unit and the main body section. Those signal lines are the “finder”, “file transfer” and “command” lines, and independently operated. This unique feature successfully realizes a satisfactory transfer capacity, the lowering of operating frequency and power consumption, and easy data management.

What is claimed is:

1. An image processing system having a camera section and a main body section which are separable one from the other, the image processing system comprising:
a first bus for transferring from the camera section to the main body section image data to check a subject on a display unit of the main body section before an image to be recorded is picked up on the main body section side;
a second bus for transferring the image file to be recorded on the main body section side from the camera section to the main body section; and
a third bus for transferring control data between the camera section and the main body section,
wherein the first bus, the second bus, and the third bus are independently used for data communication.

2. The system according to claim 1, wherein when the camera section is attached to the main body section, information unique to the camera section is transferred to the main body section through the third bus.

3. The system according to claim 2, further comprising control means for carrying out a control for the camera section based on the information unique to the camera section.

4. The system according to claim 1, wherein a video signal processing unit to which an NTSC signal is input, in place of the camera section, is connected to the main body section.

5. A main body section which composes the image processing system according to claim 1.

6. A camera section which composes the image processing system according to claim 1.

7. The system according to claim 1, wherein the first bus, the second bus, and the third bus are serial buses.

8. A method of communicating data between a camera section and a main boy section in an image processing system having the camera section and the main body section which are separable one from the other, the image processing system comprising the steps of:
using a first bus to transfer from the camera section to the main body section image data to check a subject on a display unit of the main body section before an image to be recorded is picked up on the main body section side;
using a second bus to transfer the image file to be recorded on the main body section side from the camera section to the main body section; and
using a third bus to transfer control data between the camera section and the main body section,
wherein the first bus, the second bus, and the third bus are independently used for data communication.

9. The method according to claim 8, wherein when the camera section is attached to the main body section, information unique to the camera section is transferred to the main body section through the third bus.

10. The method according to claim 9, further comprising control means for carrying out a control for the camera section based on the information unique to the camera section.

11. The method according to claim 8, wherein a video signal processing unit to which an NTSC signal is input, in place of the camera section, is connected to the main body section.

12. The method according to claim 8, wherein the first bus, the second bus, and the third bus are serial buses.
